(19) United States
(12) Patent Application Publication
(10) Pub. No.: US 2018/0192146 A1
(43) Pub. Date: Jul. 5, 2018

(54) Method and Apparatus for Playing Video Content From Any Location and Any Time

(71) Applicant: Huawei Technologies Co., Ltd., Shenzhen (CN)

(72) Inventors: Shiguo Lian, Shenzhen (CN); Zhan Qu, Shenzhen (CN); Xueyan Huang, Shenzhen (CN)

(21) Appl. No.: 15/907,985

(22) Filed: Feb. 28, 2018

Related U.S. Application Data
(63) Continuation of application No. PCT/CN2016/096568, filed on Aug. 24, 2016.

(30) Foreign Application Priority Data
Aug. 29, 2015 (CN) 201510543434.0

(51) Int. Cl. H04N 21/472; H04N 21/6587; G06F 3/01; G06F 3/0488; G06F 3/16; G10L 15/22; H04N 13/00

(52) U.S. Cl. CPC H04N 21/47217; H04N 21/6587; H04N 21/47205; G06F 3/013; G10L 2015/223; G06F 3/167; G10L 15/22; H04N 13/0014; G06F 3/0488

(57) ABSTRACT

A method and an apparatus for displaying a video from any location and any time, where the method includes obtaining a control signal input by a user, where the control signal reflects an operation intention of the user; determining a manner of displaying video content according to the control signal input by the user; determining a video playback control instruction according to characteristic information of the video content and the manner of displaying the video content, where the video playback control instruction includes a playback start location and a playback manner; and playing the video content under control of the video playback control instruction. Because the control instruction is determined according to the manner of displaying the to-be-played video, the video can be played from any location and any time.

### CROSS-REFERENCE TO RELATED APPLICATIONS

This application is a continuation of International Patent Application No. PCT/CN2016/096568 filed on Aug. 24, 2016, which claims priority to Chinese Patent Application No. 201510543434.0 filed on Aug. 29, 2015. The disclosures of the aforementioned applications are hereby incorporated by reference in their entireties.

### TECHNICAL FIELD

The present disclosure pertains to the field of man-machine interaction technologies, and in particular, to an interaction method and an apparatus for playing video content from any location and any time.

### BACKGROUND

As technologies develop and demands of people increase, more videos are propagated and watched. However, currently, playback of a video is merely simple reproduction and replay of a video source. Generally, the video is reproduced as it is captured. When a person wants to comprehensively observe an object or a scene, if the observer and the observed object are not in a same space, a solution is to take an all-angle video for the object, and the observer learns details of the object or the scene from any angle by watching the video. For example, a typical scenario is that if an online shop owner wants to display a commodity, the owner only needs to use a common photographing device such as a mobile phone to take an all-angle video by revolving around the commodity, so that a buyer can learn the commodity as if an actual object is observed. A disadvantage of this manner is that the observer can only watch the taken video, a sequence and a manner of playing video content are fixed, and the photographed object or scene cannot be watched from any location and any time.

### SUMMARY

Embodiments of the present disclosure provide an interaction method for playing video content from any location or any time, so that an observer can flexibly and arbitrarily observe an object or a scene in the video content from each location.

A first aspect of the embodiments of the present disclosure provides a method for playing a video, including obtaining a control signal input by a user, where the control signal reflects an operation intention of the user; determining a manner of displaying video content according to the control signal input by the user; determining a video playback control instruction according to characteristic information of the video content and the manner of displaying the video content, where the video playback control instruction includes a playback start location and a playback manner; and playing the video content under control of the video playback control instruction.

In an implementation manner of the first aspect, the method may further include obtaining a video source, where the video source includes the video content; and before the obtaining a control signal input by a user, displaying a preview picture of the video or playing the video content.

In an implementation manner of the first aspect, the obtaining a control signal input by a user includes receiving a voice instruction of the user, and parsing the voice instruction to obtain the control signal; detecting an action of the user, and parsing the control action to obtain the control signal; detecting a focus point change or a focus direction change of a line of sight of the user to obtain the control signal; or obtaining the control signal by detecting an operation performed by the user on an input apparatus.

In an implementation manner of the first aspect, the control signal is adjusted according to an action speed of the action or an action speed of the operation performed by the user on the input apparatus; and the manner of displaying the video content includes playing the video at an accelerated speed, at a decelerated speed, or at a normal speed; playing the video after a particular location or time is jumped to, or playing the video from a particular location or time.

With reference to any one of the foregoing manners, in an implementation solution, the manner of displaying the video content further includes forward playback, reverse playback, loop playback, or playback stopping; and the determining a manner of displaying video content according to the control signal input by the user includes performing forward playback, reverse playback, loop playback, or playback stopping of the video content according to the control signal input by the user.

In an implementation manner of the first aspect, the determining a manner of displaying video content according to the control signal input by the user includes determining a target image requirement and a motion direction requirement of video content playback according to the control signal input by the user, where a target image corresponds to a target frame; and determining the manner of displaying the video content according to the target image requirement and the motion direction requirement of video content playback.

With reference to any one of the foregoing manners, in an implementation solution, the method further includes parsing the video source to obtain a video frame from the video source, a frame number of each video frame, and the characteristic information of the video content; and the determining a video playback control instruction according to characteristic information of the video content and the manner of displaying the video content includes determining a frame number of a to-be-played target frame according to the characteristic information of the video content and the manner of displaying the video content, where the frame number of the target frame corresponds to a video playback start location or a video playback continuation location; and determining a playback sequence for playing the target frame according to the frame number of the target frame and the manner of displaying the video content, where the playback sequence corresponds to a manner of playing the target frame.

Further, the characteristic information of the video content includes motion information of target content; and the parsing the video source to obtain the characteristic information of the video content includes parsing the video source to obtain a scanning direction of video capturing, where the scanning direction is the motion information of the target content; or parsing the video source to obtain a motion track of an identified point, and obtaining the motion information of the target content according to the motion track of the identified point.

In a specific implementation of the foregoing specific solutions of the first aspect, the motion information of the target content includes a motion characteristic of the target content, where the motion characteristic includes rotation of the object from left to right, from right to left, from top to bottom, or from bottom to top.

A second aspect of the embodiments of the present disclosure provides a method for playing a video, where the method includes obtaining a video source, where the video source includes video content; parsing the video content in the video source to generate a three-dimensional (3D) image, where the 3D image is used to display an object recorded in the video content; obtaining a control signal input by a user, where the control signal reflects an operation intention of the user; and determining a manner of displaying the three-dimensional image and displaying the 3D image according to the control signal input by the user.

In an implementation manner of the second aspect, the obtaining a control signal input by a user includes receiving a voice instruction of the user, and parsing the voice instruction to obtain the control signal; detecting an action of the user, and parsing the control action to obtain the control signal; detecting a focus point change or a focus direction change of a line of sight of the user to obtain the control signal; or obtaining the control signal by detecting an operation performed by the user on an input apparatus.

In a specific implementation of the foregoing specific solutions of the second aspect, the determining a manner of displaying the 3D image and displaying the 3D image according to the control signal input by the user includes displaying the 3D image in a rotating manner according to the control signal; displaying the 3D image after a visual angle is adjusted according to the control signal; and displaying the 3D image after a magnification scale is adjusted according to the control signal.

A third aspect of the embodiments of the present disclosure provides a terminal device, including a receiver circuit configured to obtain a control signal input by a user, where the control signal reflects an operation intention of the user; a processor configured to determine a manner of displaying video content according to the control signal input by the user, and determine a video playback control instruction according to characteristic information of the video content and the manner of displaying the video content, where the video playback control instruction includes a playback start location and a playback manner; and a display configured to display and play the video content under control of the video playback control instruction.

In an implementation manner of the third aspect, the receiver circuit is further configured to obtain a video source, where the video source includes the video content; and the display is further configured to, before the receiver circuit obtains the control signal input by the user, display a preview picture of the video, or play the video content.

In an implementation manner, further, the receiver circuit is configured to receive a voice instruction of the user, and parse the voice instruction to obtain the control signal; detect an action of the user, and parse the control action to obtain the control signal; detect a focus point change or a focus direction change of a line of sight of the user to obtain the control signal; or obtain the control signal by detecting an operation performed by the user on an input apparatus.

In an implementation manner of the third aspect, the receiver circuit is further configured to adjust the control signal according to an action speed of the action or an action speed of the operation performed by the user on the input apparatus; and the processor is configured to determine the manner of displaying the video content according to the control signal input by the user, and determine the video playback control instruction according to the characteristic information of the video content and the manner of displaying the video content, where the video playback control instruction includes the playback start location and the playback manner, and the manner of displaying the video content includes forward playback, reverse playback, loop playback, or playback stopping; or playing the video at an accelerated speed, at a decelerated speed, or at a normal speed, playing the video after a particular location or time is jumped to, or playing the video from a particular location or time.

Further, in an implementation manner of the third aspect, the processor is configured to determine a target image requirement and a motion direction requirement of video content playback according to the control signal input by the user, where a target image corresponds to a target frame; determine the manner of displaying the video content according to the target image requirement and the motion direction requirement of video content playback; and determine the video playback control instruction according to the characteristic information of the video content and the manner of displaying the video content, where the video playback control instruction includes the playback start location and the playback manner.

With reference to any one of the foregoing manners, in an implementation solution of the third aspect, the processor is further configured to parse the video source to obtain a video frame from the video source, a frame number of each video frame, and the characteristic information of the video content; determine a frame number of a to-be-played target frame according to the characteristic information of the video content and the manner of displaying the video content, where the frame number of the target frame corresponds to a video playback start location or a video playback continuation location; and determine a playback sequence for playing the target frame according to the frame number of the target frame and the manner of displaying the video content, where the playback sequence corresponds to a manner of playing the target frame.

A fourth aspect of the embodiments of the present disclosure provides a terminal, including a receiver circuit configured to obtain a video source and a control signal input by a user, where the video source includes video content, and the control signal reflects an operation intention of the user; a processor configured to parse the video content in the video source to generate a 3D image, where the 3D image is used to display an object recorded in the video content, and determine a manner of displaying the 3D image according to the control signal input by the user; and a display configured to display the 3D image under control of the processor.

In an implementation manner of the fourth aspect, the receiver circuit is configured to obtain the video source, and is further configured to receive a voice instruction of the user, and parse the voice instruction to obtain the control signal; detect an action of the user, and parse the control action to obtain the control signal; detect a focus point change or a focus direction change of a line of sight of the user to obtain the control signal; or obtain the control signal by detecting an operation performed by the user on an input apparatus.

In the embodiments of the present disclosure, a video playback control instruction is determined according to characteristic information of video content and a manner of displaying the video content. The manner of displaying the video content is determined according to a control signal input by a user; therefore, the user can flexibly play the video content, and can watch an object in an all-angle video from any angle according to an intention of the user (an operator, an observer, or a person who plays the video). Therefore, an interaction process is more convenient, which is equivalent to directly controlling the object in the video for an operator, thereby providing more real experience and implementing selection of a manner of reproducing content in a video source in a personalized and customized manner. By means of the solutions in the embodiments of the present disclosure, instead of simple reproduction of recorded video content, a user can display video content source using any visual angle, any playback sequence, or any playback manner. The user can determine manners of displaying and playing the video content by inputting a control instruction, so that to-be-played video content and a playback manner are selected according to an intention of the person who plays the video.

### BRIEF DESCRIPTION OF THE DRAWINGS

To describe the technical solutions in the embodiments of the present disclosure more clearly, the following briefly describes the accompanying drawings required for describing the embodiments of the present disclosure. The accompanying drawings in the following description show merely some embodiments of the present disclosure, and a person of ordinary skill in the art may still derive other drawings from these accompanying drawings without creative efforts.

FIG. 1 is a flowchart of implementing an interaction method for playing a video from any location and any time according to an embodiment of the present disclosure;

FIG. 2 is a schematic diagram of a sliding operation according to an embodiment of the present disclosure;

FIG. 3 is a schematic diagram of an all-angle video of an object rotating from left to right according to an embodiment of the present disclosure;

FIG. 4 is a schematic diagram of an all-angle video of an object rotating from right to left according to an embodiment of the present disclosure;

FIG. 5 is a schematic diagram of an all-angle video of an object rotating from top to bottom according to an embodiment of the present disclosure;

FIG. 6 is a schematic diagram of an all-angle video of an object rotating from bottom to top according to an embodiment of the present disclosure; and

FIG. 7 is a schematic structural diagram of an intelligent terminal for implementing video playback from any location and any time according to an embodiment of the present disclosure.

### DETAILED DESCRIPTION

To make the objectives, technical solutions, and advantages of the present disclosure clearer and more comprehensible, the following further describes the present disclosure in detail with reference to the accompanying drawings and embodiments. It should be understood that the specific embodiments described herein are merely used to explain the present disclosure but are not intended to limit the present disclosure.

In an embodiment of the present disclosure, for example, a video source is obtained by performing 360-degree (or approximately 360-degree) video capturing on an object, an image, or an environment, so that a relatively comprehensive video record of the object or the image can be obtained. The video content in the video source is reproduced in a customized and personalized manner (a playback location, a playback sequence, a playback manner, or a playback visual angle) according to a manner of displaying video content that is determined according to a control signal input by a user. In this embodiment of the present disclosure, instead of simply reproducing the video, the playback manner, the playback location, and the like of the video content may be defined.

Video content captured from an original video source may be comprehensive information about a big environment. There are multiple targets or objects in the big environment. For each target or object, 360-degree (or approximately 360-degree) video capturing is performed. In a process of playing the video content, the targets or the objects may be fully displayed sequentially. Further, in the process of playing the video, if an instruction or a control gesture signal is received, a target or a time period of the video may be skipped to continue to display comprehensive information about a next target, and this target may be displayed in the video content in a customized or personalized manner. This process may be implemented by searching or matching the video content.

In this embodiment of the present disclosure, based on an instruction input by a user, a video can be played from any location and any time point of the video content, or during video playback, any clip in the video content may be skipped. For example, in an implementation, an input instruction of a user may be a fast-forward instruction. During video processing, a fast-forward time period is set to a time period for displaying information related to a target. Therefore, a fast-forward control signal may match jumping from a current target to a next target or a target specified by the user, and content, corresponding to the next target, of the video is played according to a playback manner controlled by the user. The user may also watch an image of a particular scene or object by means of voice input, and after matching, start playback from a corresponding location that is jumped to.

To further describe the technical solutions in the embodiments of the present disclosure, a description is provided below using specific embodiments.

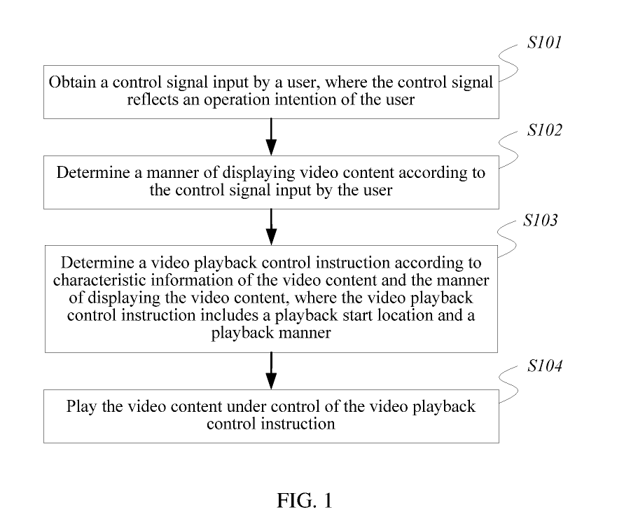

FIG. 1 shows a process of implementing a method for playing video content from any location and any time according to an embodiment of the present disclosure, and the method includes the following steps.

S101: Obtain a control signal input by a user, where the control signal reflects an operation intention of the user.

The control signal input by the user is triggered and generated by detecting an operation (for example, an operation on a touchscreen) performed by the user on an intelligent terminal such as sliding on a touchscreen; or the control signal input by the user may be triggered and generated by detecting a control action of the user such as a hand wave, a finger movement, finger twirling, palm opening and wrist rotating, gazing or line-of-sight diversion, a head movement, or a body movement; or the control signal input by the user may also be voice input, and the voice input is detected using a microphone.

The control signal reflects the operation intention of the user, that is, the control signal reflects an operation that the user wants to perform on the video and is a control signal obtained after the operation intention of the user is signalized.

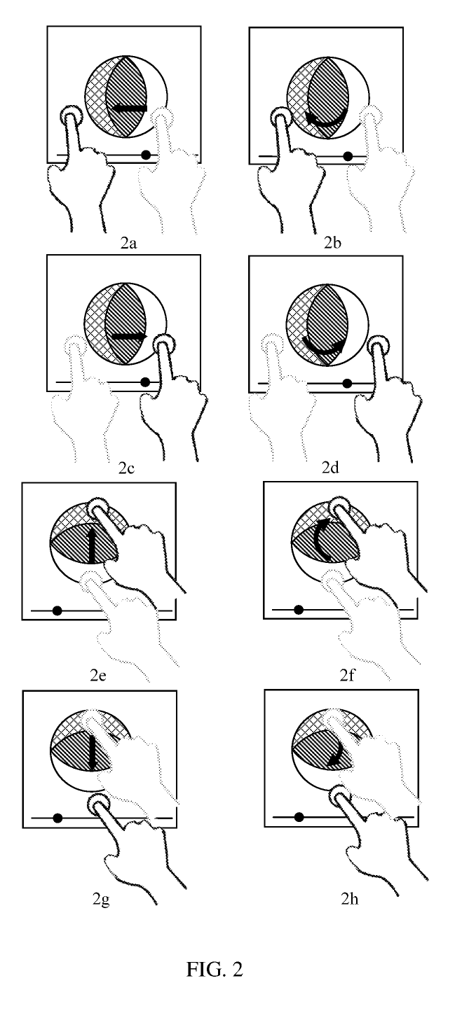

The control signal input by the user is obtained. For example, sliding on the touchscreen includes sliding leftward, rightward, upward, and downward (FIG. 2A, FIG. 2C, FIG. 2E, and FIG. 2G), and sliding approximately leftward, rightward, upward, and downward. For example, a leftward curve (FIG. 2B) may also be considered as sliding approximately leftward, a rightward curve (FIG. 2D) may also be considered as sliding approximately rightward, an upward curve (FIG. 2F) may also be considered as sliding approximately upward, and a downward curve (FIG. 2H) may also be considered as sliding approximately downward.

Similarly, a hand wave or a finger movement includes leftward, rightward, upward, and downward waves or movements, and approximately leftward, rightward, upward, and downward waves or movements. For example, a leftward curving wave or movement may also be considered as an approximately leftward wave or movement; and rightward, upward, and downward cases are similar.

The input of the user is obtained using a sensor, where finger twirling includes leftward twirling, rightward twirling, upward twirling, and downward twirling.

The input of the user is obtained using a sensor, where palm opening and wrist rotating include rotating from left to right, rotating from right to left, rotating from top to bottom, and rotating from bottom to top.

The input of the user is obtained using a sensor, where gazing or line-of-sight diversion includes gazing at an upper part of a picture of the video or diverting a line of sight from front to an upper part. Similarly, gazing or line-of-sight diversion further includes gazing at a lower part, a left part, or a right part of a picture of the video, or diverting a line of sight from front to a lower part, to a left part, or to a right part.

The voice input of the user is obtained using a microphone, where a voice instruction includes an instruction such as “move left” and “turn left” or an instruction of a similar meaning, and rightward, upward, and downward instructions are similar to the foregoing. A voice instruction for playing a particular image, for example, playing a video of an X object at a top angle, and playing a panorama of a Y object from left to right, may also be output to determine a location of the video.

The input of the user is obtained using a sensor, where a head movement includes a head movement to left front, a head movement to right front, looking up, or looking down.

The input of the user is obtained using a sensor, where a body movement includes a movement to left front or front, an upward body movement, or a downward body movement.

For the foregoing directions, the user is used as a reference. The foregoing left side is the left side relative to the user, and the foregoing right side is the right side relative to the user. Inevitably, some users are accustomed to using an object in a picture of a video as a reference to describe concepts “left” and “right”, and in this case, “left” and “right” can be switched in a corresponding voice instruction.

In this embodiment, one manner or a combination of multiple manners of the following may be used to obtain the input of the user, including obtaining a finger sliding movement of the user using a touch sensor; obtaining a gesture movement of the user, or a direction of a head movement or a body movement of the user by analyzing images captured by a camera or using technologies such as an infrared technology and an ultrasonic wave technology; obtaining a focus point change or a diversion direction change of a line of sight of the user using a line-of-sight tracking sensor; and obtaining voice of the user using a microphone. Further, in a case in which finger sliding of the user is obtained using the touch sensor, the input of the user may also include pressure of an operation of the user obtained using a pressure sensor.

In an implementation, for example, if a user wants to watch an object in a video image, the user may perform an operation on the object on the image using a touchscreen or a gesture to control the video to play a video corresponding to the object, such as rotating the object and playing an image of the object from left to right.

In this embodiment, before the obtaining a control signal input by a user, the method further includes displaying a preview picture of the video or playing the video.

S102: Determine a manner of displaying video content according to the control signal input by the user.

The manner of displaying the video content reflects an intention of the user (an observer or a person who plays the video). The manner of displaying the video content includes a visual angle for playing content in a picture of the video, a rotation direction of target content, a reproduction manner, skipping target content to continue playback, or the like.

A target image requirement and a motion direction requirement of video content playback are determined according to the control signal input by the user, where a target image corresponds to a target frame, and the manner of displaying the video content is determined according to the target image requirement and the motion direction requirement of video content playback. The target frame is determined first, and after the target frame is determined, a location of the video may be determined, and then according to the control signal, it can be determined whether fast-forwarding or rewinding is to be performed, or whether the video is to be played from a visual angle of a left-to-right sequence, or the like. These are the target image requirement and the motion direction requirement of video content playback that are obtained according to the control signal.

Determining a visual angle requirement for watching the content in the picture of the video preferably includes determining a change of a watching visual angle according to a motion direction and a motion increment that are input by the user, to determine the visual angle requirement for watching.

The motion increment includes a displacement increment of a start point of a sliding track, and a displacement increment of a start point of a motion track of a hand wave or finger movement; a change of a finger movement angle during finger twirling; a change of a wrist rotating angle during palm opening and wrist rotating; a displacement increment of a line of sight from a gazing start point to a gazing end point during gazing or line-of-sight diversion; a preset visual angle change during output of each voice instruction; a displacement increment of a start point of a motion track of a head movement; and a displacement increment of a start point of a motion track of a body movement.

For example, a visual angle increment DeltV is determined using a motion increment DeltX, and a visual angle parameter V_{—i} is obtained by means of accumulation. V_{—i}=V_{—i}−1+DeltV=V_{—i}−1+alfa*DeltX, where alfa>0, and a value interval of V_{—i} is [0, 1].

The determining a rotation direction requirement on an object in the picture of the video includes obtaining a motion direction input by the user, where the rotation direction requirement on the object in the picture of the video is the same as the motion direction input by the user.

S103: Determine a video playback control instruction according to characteristic information of the video content and the manner of displaying the video content, where the video playback control instruction includes a playback start location and a playback manner.

The playback control instruction is used to implement the intention of the user, for example, a visual angle requirement for watching an object in the picture of the video and a rotation direction requirement on the object in the picture of the video of the user.

The video playback control instruction includes a playback start location and a playback manner. The playback start location corresponds to a target frame to be played, and a playback start location or a playback continuation location may be determined by determining the target frame. The playback manner may be a forward direction (forward), a reverse direction (backward), fast-forwarding, rewinding, and the like, or may be a manner of playing a video from a visual angle of rotating around an object or a target.

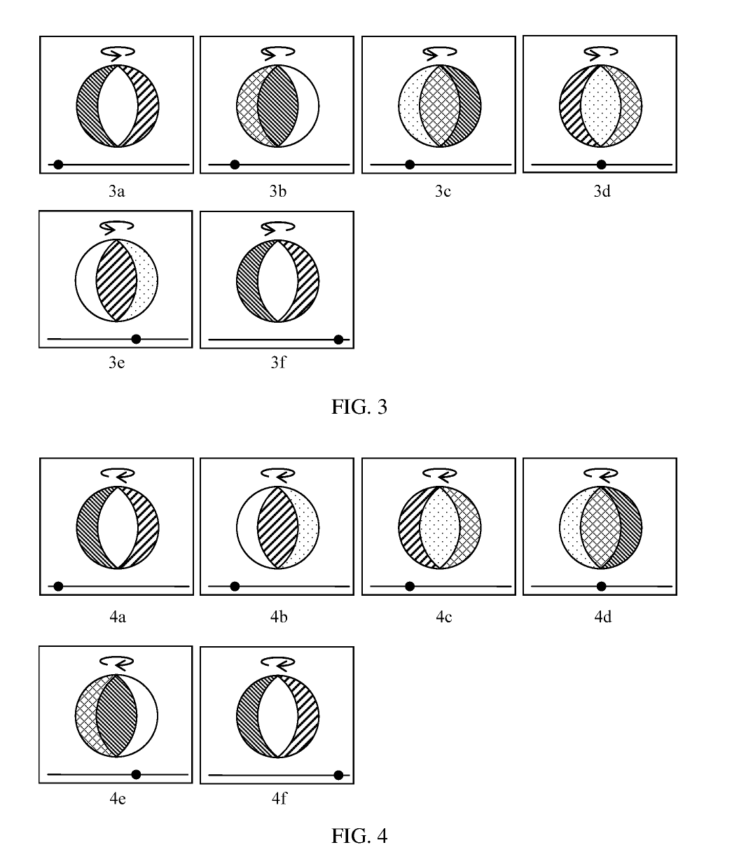

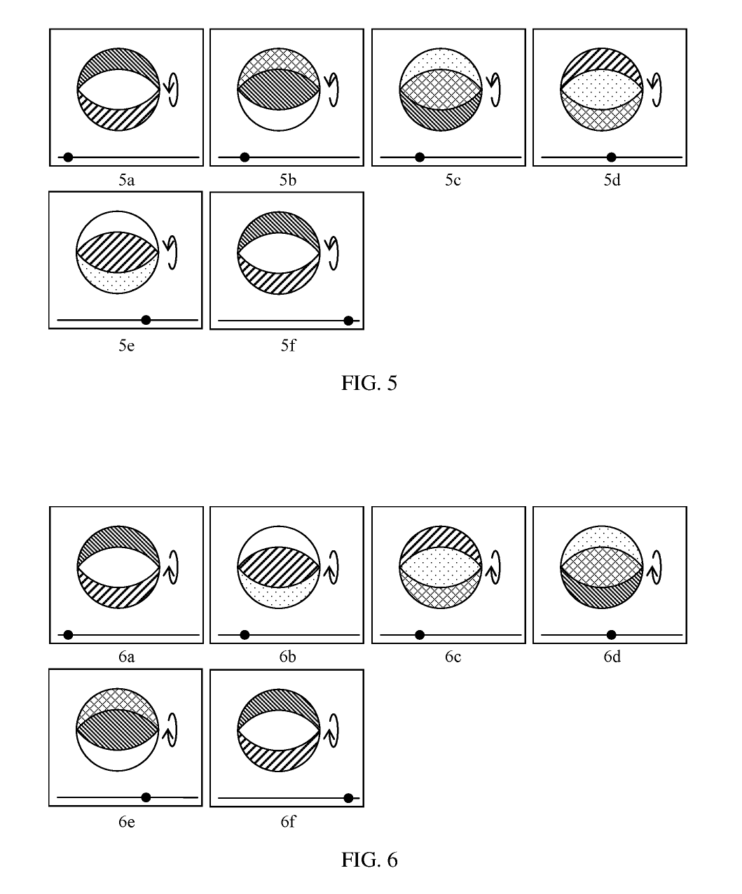

In an implementation, the characteristic information of the video may include location information of an object and motion information of target content in the picture of the video. The motion information is, for example, rotation information; and a rotation characteristic of the object in the picture of the video includes rotating from left to right (FIG. 3A to FIG. 3F), from right to left (FIG. 4A to FIG. 4F), from top to bottom (FIG. 5A to FIG. 5F), and from bottom to top (FIG. 6A to FIG. 6F) as the video is played.

In an embodiment of the present disclosure, a method is provided to determine a rotation characteristic of an object in a picture of a video. In this method, it is required that extra rotation direction information is recorded during a video taking process. A photographing device needs to be equipped with a sensor in a motion status such as a three-axis gyroscope, during the photographing process, a direction in which the photographing device photographs a photographed object is recorded in a video file, and direction data is read when the video file is parsed, so that a rotation characteristic of the photographed object is determined.

In another embodiment of the present disclosure, another method is provided to analyze a rotation characteristic of an object in any video. In this method, no extra record is required during a photographing process. The object in the video may be analyzed. An identified point on the object is defined, a motion track of the identified point during normal playback of the video is analyzed, and the rotation characteristic of the object is determined according to a direction of the motion track.

In a specific implementation, a video source is obtained by performing 360-degree (or approximately 360-degree) video capturing on an object or an image, so that a comprehensive video record of the object or the image can be obtained. The video content in the video source is reproduced in a customized manner according to the manner of displaying the video content determined according to the control signal input by the user.

The determining a video playback control instruction includes determining an appropriate video playback location and an appropriate video playback manner.

The video playback control instruction may implement forward playback or reverse playback of the video; a playback start location or a playback start time; a playback visual angle and a playback location or time after fast-forwarding or jumping; loop playback of the video; playing the video at an accelerated speed, at a decelerated speed, or at a normal speed; and pausing or stopping playback of the video.

A video generated in a process of photographing an object is essentially a picture sequence formed by pictures of all angles (360 degrees or approximately 360 degrees) of the object, and three pieces of data are recorded in a video file, including P′, that is, a compressed picture sequence, Q, that is, a scanning direction (0 indicates from left to right; 1 indicates from right to left; 2 indicates from top to bottom; and 3 indicates from bottom to top), and N+1, that is, a quantity of pictures. The picture sequence is represented by Pi, where i ranges from 0 to N and N is an integer. That is, serial numbers of pictures are P₀, P₁, P₂, . . . , and P_{N}. The scanning direction is determined and obtained by a three-axis gyroscope on a photographing device. A total quantity of the pictures is N+1.

A playback terminal parses the video file to obtain the three pieces of data P′, that is, a compressed picture sequence, Q, that is, a scanning direction, and N+1, that is, a quantity of pictures.

According to the watching visual angle V, determined in step S102, a target frame O_{—i} is calculated using the following formula:

Q=0 or Q=2, O_{—i}=V_{—i}*(N+1); and

Q=1 or Q=3, O_{—i}=(1−V_{—i})*(N+1).

Sometimes the video is viewed after the photographing is completed, and in this case, a photographing terminal is also a playback terminal. After the video is transmitted, the playback terminal is different from the photographing terminal. In an implementation, a process of parsing the video file to obtain various types of information of the video frame may be completed on a playback terminal that receives the video; or may be completed on a photographing terminal or an intermediate service device. The various types of information of the video frame and video content are sent together to a receiving terminal acting as the playback terminal.

A method for determining the appropriate video playback manner is comparing the rotation direction requirement on the object in the picture of the video and the rotation characteristic of the object in the picture of the video; and when the two are the same, playing the video in a forward direction; or when the two are opposite, playing the video in a reverse direction.

For example, an input of a user is sliding from left to right, and it indicates that a rotation direction requirement of the user is from left to right, and an object in a picture of a video is also rotated from left to right. In this case, the rotation direction requirement of the user is the same as a rotation characteristic of the object. Therefore, the video is played to a target frame in a forward direction. If the object in the picture of the video is rotated from right to left, the rotation direction requirement of the user and the rotation characteristic of the object are opposite, the video is played to the target frame in a reverse direction.

FIG. 4 is used as an example for description. If a current video playback frame is 4a and a target frame is 4c, and a rotation characteristic of an object in a picture of a video is from left to right, and it is assumed that the video is played on a touchscreen device, when a user slides rightward on the video, that is, a motion direction input by the user is the same as the rotation characteristic of the object in the picture of the video, the video is played in a sequence 4a-4b-4c, that is, the video is played to the target frame 4c in a forward direction. When the user slides leftward on the video, that is, the motion direction input by the user is opposite to the rotation characteristic of the object in the picture of the video, the video is played in a sequence 4a/4f-4e-4d-4c, that is, the video is played to the target frame 4c in a reverse direction.

The video playback control instruction may further include loop playback of the video. When the video is played to the end or beginning, the video may continue to be played from the beginning or end, so that the user can experience that the object is rotated continuously.

The video playback control instruction includes playing the video at an accelerated speed, at a decelerated speed, or at a normal speed. When the input of the user is sliding on the touchscreen, a hand wave or a finger movement, finger twirling, palm opening, and wrist rotating, the video is played at an accelerated speed, at a decelerated speed, or at a normal speed according to a speed of the input of the user. When the input of the user is sliding on the touchscreen, the video is played at an accelerated speed, at a decelerated speed, or at a normal speed according to a pressure value of the input of the user.

The video playback control instruction includes pausing or stopping playback of the video. When the user pauses or stops the input, the video is also paused or stopped, so that instead of watching a video, the user experiences really operating an object. That is, the video may not be played completely but is played according to an action of the user. Using FIG. 5 as an example, an object in FIG. 5 is rotated from right to left, a current playback frame is 5A and a target frame is 5D, an input of a user is sliding from right to left. Therefore, a video is played in a forward direction. It is assumed that when the video is played to 5D, the user pauses the input, that is, the video is played according to a sequence 5A-5B-5C-5D and is paused at 5D, and then the input of the user is sliding from left to right, the video is played from 5D in a reverse direction. It is assumed that the user pauses the input when the video is played to 5B, that is, the video is played according to a sequence 5D-5C-5B and is paused at 5D.

S104: Play the video content under control of the video playback control instruction.

Further, in another embodiment of the present disclosure, because interaction processes implemented in the present disclosure are in a file of a video type, and storage space occupied by the video file is relatively large, a requirement on storage space of user equipment is relatively high or a running speed of the user equipment is affected. To improve practical applicability of the present disclosure, 3D modeling may be performed for the object in the picture of the video in the present disclosure, and after the video source is received, the video source is parsed and a 3D image is reconstructed. The video content in the video source is parsed to generate a 3D image, where the 3D image is used to display an object recorded in the video content. A display displays the 3D image, and the user equipment receives the control signal input by the user using the foregoing method, where the control signal reflects an operation intention of the user. A manner of displaying the 3D image is determined according to the control signal input by the user, and the 3D image is displayed.

In this embodiment, a device that needs to take an all-angle video is equipped with a depth sensor, and 3D scene information registration software and texture fusion and mapping software are installed on the device. In a photographing process, the depth sensor is enabled, so that a camera of the device that photographs the all-angle video and the depth sensor work synchronously, and a photographer holding the photographing device perform continuous photographing on a scene for which modeling is required. In a specific implementation process, a time interval may be given, and the depth sensor performs photographing to obtain one frame of 3D point cloud data in front of the depth sensor at each time interval, where point cloud data obtained by means of photographing at a time t is represented by Ft. The camera takes a picture of a scene, that is, texture data, at the same time, where the texture data is represented by It. After the photographing is completed, a point cloud sequence and an image sequence are stored in the photographing device, the point cloud sequence is registered to a dense point cloud using the 3D scene information registration software, and this point cloud reflects 3D space information of the target scene.

Local registration between adjacent frames is performed first on the point cloud sequence, for each point u_i in a point cloud F_j, F_(j+1) is searched for a point v_i closest to the u_i, and a correspondence (u_i, v_i) is established. According to relationships between all corresponding points in point clouds of two frames, the following target function is established:

$$E = {\sum }_{i = 1}^{n} {\vert {Ru}_{i} + t - {v}_{i} \vert}^{2} ,$$

where n is a quantity of all corresponding point pairs in the point clouds F_j and F_(j+1). When E is minimized, an error of a squared Euclidean distance between corresponding points is minimized, and when optimization is completed, attitude change parameters R and t between the point clouds of two frames may be obtained, thereby implementing registration between adjacent frames.

Attitude change parameters of point clouds of adjacent frames are calculated using a local registration algorithm, a whole point cloud sequence may be integrated into a dense point cloud of a target scene according to these parameters, and T_k (⋅) is used to indicate that an attitude change operation is performed on a given point cloud according to an attitude change parameter (p_k) between F_k and F_(k+1), that is, T_k(⋅)=R_k (⋅)+t_k, and the following attitude change operation is redefined:

Tₖ′(⋅)=Tₖ₊₁′(Tₖ(⋅)),K K,T_{N-1}′(⋅)=T_{N-1}(⋅),

where k={1, 2, . . . , and N−2}, and an accumulated point cloud is represented by F′:

F′=T₁′(F₁)+T₂′(F₂)+L+T_{N-1}′(F_{N-1})+F_{N}.

Because relative attitudes of the camera on the photographing device and the depth sensor are determinate, and image data and point cloud data are simultaneously obtained by means of photographing, when a space attitude parameter of the depth sensor shooting each point cloud frame is obtained, a space attitude parameter of the camera taking each picture is also obtained. Therefore, a correspondence between texture data (image) obtained by means of photographing by the camera and a scene dense point cloud may be constructed, and high-definition texture data is rendered into a 3D model of the scene using texture fusion and mapping software, so as to form a highly precise scene 3D reconstruction model.

In this case, in step S102, a visual angle requirement of the user for watching may be directly determined according to the input of the user. In step S103, in a specific method for determining the target frame in the video, the target frame in the video is determined according to a space attitude parameter of each frame in the video that corresponds to the visual angle requirement for watching. A corresponding space attitude parameter may be determined according to the visual angle for watching, a space attitude parameter closest to the corresponding space attitude parameter is obtained from a set of the space attitude parameters of the frames in the video by means of matching, and a frame corresponding to the matched space attitude parameter is the target frame.

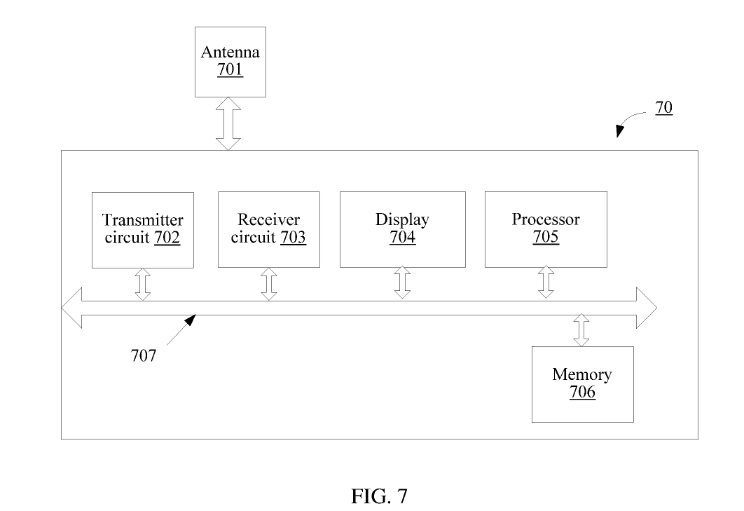

FIG. 7 shows an intelligent terminal 70 for implementing the foregoing methods according to an embodiment of the present disclosure. The intelligent terminal may be a terminal device having a media playback function such as a smartphone, a mobile personal computer, a media player, and a portable audio-video device. For ease of description, only a part related to this embodiment is shown. The intelligent terminal can perform somatosensory interaction. The intelligent terminal 70 is a device or an apparatus for implementing the foregoing method embodiments, and therefore, each component or physical function hardware of the intelligent terminal 70 can implement each step in the foregoing method embodiments and can perform each process in the foregoing method embodiments. Therefore, the intelligent terminal uses the foregoing method to play video content from any location and any time.

The intelligent terminal 70 includes an antenna 701, a transmitter circuit 702, a receiver circuit 703, a display 704, a processor 705, a memory 706, a bus 707, and the like. Components of the intelligent terminal 70 are coupled together using the bus system 707. In addition to a data bus, the bus system 707 further includes a power supply bus, a control bus, and a state signal bus. However, for the purpose of clear description, various buses in the figure are marked as the bus system 707. However, in the terminal for implementing this embodiment of the present disclosure, for example, the transmitter circuit 702 may be optional or unnecessary. The intelligent terminal 70 is configured to receive a video source and a signal, but does not send the video source or the signal. In this embodiment of the present disclosure, the antenna is also optional or unnecessary. This embodiment of the present disclosure may be implemented in a wired manner. Although some functions may be affected in this solution, the wired manner is also an option. The memory 706 may be configured to store the obtained video source.

In an implementation manner, the provided intelligent terminal 70 includes the receiver circuit 703 configured to obtain a control signal input by a user, where the control signal reflects an operation intention of the user; the processor 705 configured to determine a manner of displaying video content according to the control signal input by the user, and determine a video playback control instruction according to characteristic information of the video content and the manner of displaying the video content, where the video playback control instruction includes a playback start location and a playback manner; and the display 704 configured to display and play the video content under control of the video playback control instruction.

Further, in a manner, the receiver circuit 703 is further configured to obtain a video source, where the video source includes the video content. In the solution of this manner, the display 704 is further configured to, before the receiver circuit obtains the control signal input by the user, display a preview picture of the video, or play the video content. In another implementation manner, the receiver circuit 703 may receive a voice instruction of the user, and parse the voice instruction to obtain the control signal; detect an action of the user, and parse the control action to obtain the control signal; detect a focus point change or a focus direction change of a line of sight of the user to obtain the control signal; or obtain the control signal by detecting an operation performed by the user on an input apparatus connected to the receiver circuit.

In a manner that can be combined with the foregoing manner, the receiver circuit 703 is further configured to adjust the control signal according to an action speed of the action or an action speed of the operation performed by the user on the input apparatus connected to the receiver circuit. Further, the processor 705 is configured to determine the manner of displaying the video content according to the control signal input by the user; and determine the video playback control instruction according to the characteristic information of the video content and the manner of displaying the video content, where the video playback control instruction includes the playback start location and the playback manner. The manner of displaying the video content includes forward playback, reverse playback, loop playback, or playback stopping; or playing the video at an accelerated speed, at a decelerated speed, or at a normal speed, playing the video after a particular location or time is jumped to, or playing the video from a particular location or time.

The processor 705 can determine a target image requirement and a motion direction requirement of video content playback according to the control signal input by the user, where a target image corresponds to a target frame; determine the manner of displaying the video content according to the target image requirement and the motion direction requirement of video content playback; and determine the video playback control instruction according to the characteristic information of the video content and the manner of displaying the video content, where the video playback control instruction includes the playback start location and the playback manner.

The processor may further parse the video source to obtain a video frame from the video source, a frame number of each video frame, and the characteristic information of the video content; determine a frame number of a to-be-played target frame according to the characteristic information of the video content and the manner of displaying the video content, where the frame number of the target frame corresponds to a video playback start location or a video playback continuation location; and determine a playback sequence for playing the target frame according to the frame number of the target frame and the manner of displaying the video content, where the playback sequence corresponds to a manner of playing the target frame.

In another embodiment used for describing the solution, the receiver circuit 703 is configured to obtain the input of the user. Preferably, the receiver circuit 703 is configured to obtain a finger sliding movement of the user using a touch sensor; obtain a gesture movement of the user, or a direction of a head movement or a body movement by analyzing images captured by a camera or using technologies such as an infrared technology and an ultrasonic wave technology; obtain a focus point change or a focus direction change of a line of sight of the user using a line-of-sight tracking sensor; and obtain voice of the user using a microphone, where the input of the user includes sliding on a touchscreen; a hand wave or a finger movement; finger twirling, palm opening and wrist rotating, gazing or line-of-sight diversion, outputting a voice instruction, a head movement, and a body movement. The input of the user may also include pressure of an operation of the user.

The input of the user is obtained, sliding on the touchscreen includes sliding leftward, rightward, upward, and downward (FIG. 2A, FIG. 2C, FIG. 2E, and FIG. 2G), and sliding approximately leftward, rightward, upward, and downward. For example, a leftward curve (FIG. 2B) may also be considered as sliding approximately leftward, a rightward curve (FIG. 2D) may also be considered as sliding approximately rightward, an upward curve (FIG. 2F) may also be considered as sliding approximately upward, and a downward curve (FIG. 2H) may also be considered as sliding approximately downward.

Similarly, a hand wave or a finger movement includes leftward, rightward, upward, and downward waves or movements, and approximately leftward, rightward, upward, and downward waves or movements. For example, a leftward curving wave or movement may also be considered as an approximately leftward wave or movement; and a rightward, upward, or downward curving wave or movement may also be considered as an approximately rightward, upward, or downward wave or movement.

The input of the user is obtained, and finger twirling includes leftward twirling, rightward twirling, upward twirling, and downward twirling.

The input of the user is obtained, and palm opening and wrist rotating include rotating from left to right, from right to left, from top to bottom, and from bottom to top.

The input of the user is obtained, and gazing or line-of-sight diversion includes gazing at an upper part of a picture of the video or a line of sight is diverted from front to an upper part. Similarly, the gazing or line-of-sight diversion further includes gazing at a lower part, a left part, and a right part of the picture of the video, or the line of sight is diverted from front to a lower part, to a left part, or to a right part.

The input of the user is obtained, a voice instruction includes an instruction such as “move left” and “turn left” or an instruction of a same meaning, and rightward, upward, and downward instructions are similar to the foregoing.

The input of the user is obtained, and a head movement includes a head movement to left front, a head movement to right front, looking up, or looking down.

The input of the user is obtained, and a body movement includes a movement to left front or front, an upward body movement, or a downward body movement.

For the foregoing directions, the user is used as a reference. The foregoing left side is the left side relative to the user, and the foregoing right side is the right side relative to the user. Inevitably, some users are accustomed to using an object in a picture of a video as a reference to describe concepts “left” and “right”, and in this case, in a corresponding voice instruction, “left” and “right” can be switched.

The processor 705 is configured to determine an intention of the user according to the input of the user, and determine the video playback control instruction according to the intention of the user and a characteristic of the video. The determining the intention of the user includes determining a visual angle requirement for watching an object in the picture of the video and a rotation direction requirement on the object in the picture of the video. The determining the visual angle requirement for watching the object in the picture of the video optionally includes determining a change of a watching visual angle according to a motion direction and a motion increment that are input by the user, and then determining the visual angle requirement for watching. The determining the rotation direction requirement on the object in the picture of the video includes obtaining a motion direction input by the user, where the rotation direction requirement on the object in the picture of the video is the same as the motion direction input by the user. The determining a video playback control instruction includes determining an appropriate playback location and an appropriate playback manner. The video playback control instruction includes forward playback or reverse playback of the video, loop playback of the video, playing the video at an accelerated speed, at a decelerated speed, or at a normal speed; and pausing or stopping playback of the video. A method for determining the appropriate video playback location is determining a target frame in the video according to the visual angle requirement for watching the object in the picture of the video. A method for determining the appropriate video playback manner is comparing a rotation direction requirement on the object in the picture of the video and a rotation characteristic of the object in the picture of the video; and when the two are the same, playing the video in a forward direction, or when the two are opposite, playing the video in a reverse direction.

The processor 705 is configured to execute the video playback control instruction and control the display 704 to display a corresponding video image. The processor 705 may further determine a location and the rotation characteristic of the object in the picture of the video. The rotation characteristic of the object in the picture of the video includes rotating from left to right (FIG. 3), from right to left (FIG. 4), from top to bottom (FIG. 5), and from bottom to top (FIG. 6).

Further, in another embodiment of a 3D image in an implementation method, a structure of the intelligent device may be the structure shown in FIG. 7. As a new intelligent terminal 70′, the intelligent terminal 70′ includes a receiver circuit 703′ configured to obtain a video source and a control signal input by a user, where the video source includes video content, and the control signal reflects an operation intention of the user; a processor 705′ configured to parse the video content in the video source to generate a 3D image, where the 3D image is used to display an object recorded in the video content, and determine a manner of displaying the 3D image according to the control signal input by the user; and a display 704′ configured to display the 3D image under control of the processor.

In an implementation solution, the receiver circuit 703′ is configured to obtain the video source; and is further configured to receive a voice instruction of the user, and parse the voice instruction to obtain the control signal; detect an action of the user, and parse the control action to obtain the control signal; detect a focus point change or a focus direction change of a line of sight of the user to obtain the control signal; or obtain the control signal by detecting an operation performed by the user on an input apparatus connected to the receiver circuit.

In each embodiment of the intelligent terminal, details about performing terminal or implementing video playback by the terminal are not described in the solution, because the details are already described in the method embodiments. All parts of the method may be inherited for implementing, by the intelligent terminal, the video playback in this embodiment of the present disclosure. The processor may cooperate with other components to fully implement the steps and functions of the method embodiments.

In this embodiment of the present disclosure, a video playback control instruction is determined according to characteristic information of video content and a manner of displaying the video content. The manner of displaying the video content is determined according to a control signal input by a user; therefore, the user can flexibly play the video content, and can watch an object in an all-angle video from any angle according to an intention of the user (an operator, an observer, or a person who plays the video). Therefore, an interaction process is more convenient, which is equivalent to directly controlling the object in the video for an operator, thereby providing more real experience and implementing selection of a manner of reproducing content in a video source in a personalized and customized manner.

What is claimed is:

1. A method for playing a video, comprising:
obtaining a control signal from a user, wherein the control signal reflects an operation intention of the user;
determining a manner of displaying video content according to the control signal from the user;
determining a video playback control instruction according to characteristic information of the video content and the manner of displaying the video content, wherein the video playback control instruction comprises a playback start location and a playback manner; and
playing the video content under control of the video playback control instruction.

2. The method according to claim 1, further comprising:
obtaining a video source, wherein the video source comprises the video content; and
displaying a preview picture of the video or playing the video content before obtaining the control signal from the user.

3. The method according to claim 1, wherein obtaining the control signal from the user comprises:
receiving a voice instruction of the user and parsing the voice instruction to obtain the control signal;
detecting an action of the user and parsing the control action to obtain the control signal;
detecting a focus point change or a focus direction change of a line of sight of the user to obtain the control signal; or
obtaining the control signal by detecting an operation performed by the user on an input apparatus.

4. The method according to claim 3, wherein the control signal is adjusted according to an action speed of the action or an action speed of the operation performed by the user on the input apparatus, and wherein the manner of displaying the video content comprises playing the video at an accelerated speed, at a decelerated speed, at a normal speed, playing the video after a particular location or time is jumped to, or playing the video from a particular location or time.

5. The method according to claim 1, wherein the manner of displaying the video content comprises forward playback, reverse playback, loop playback, or playback stopping, and wherein determining the manner of displaying the video content according to the control signal from the user comprises performing forward playback, reverse playback, loop playback, or playback stopping of the video content according to the control signal input by the user.

6. The method according to claim 1, wherein determining the manner of displaying the video content according to the control signal from the user comprises:
determining a target image requirement and a motion direction requirement of video content playback according to the control signal input by the user, wherein a target image corresponds to a target frame; and
determining the manner of displaying the video content according to the target image requirement and the motion direction requirement of video content playback.

7. The method according to claim 1, wherein the method further comprises parsing the video source to obtain a video frame from the video source, a frame number of each video frame, and the characteristic information of the video content, and wherein determining the video playback control instruction according to the characteristic information of the video content and the manner of displaying the video content comprises:
determining a frame number of a to-be-played target frame according to the characteristic information of the video content and the manner of displaying the video content, wherein the frame number of the target frame corresponds to a video playback start location or a video playback continuation location; and
determining a playback sequence for playing the target frame according to the frame number of the target frame and the manner of displaying the video content, wherein the playback sequence corresponds to a manner of playing the target frame.

8. The method according to claim 7, wherein the characteristic information of the video content comprises motion information of target content, and wherein parsing the video source to obtain the characteristic information of the video content comprises:
parsing the video source to obtain a scanning direction of video capturing, wherein the scanning direction is the motion information of the target content; or
parsing the video source to obtain a motion track of an identified point and obtaining the motion information of the target content according to the motion track of the identified point.

9. The method according to claim 8, wherein the motion information of the target content comprises a motion characteristic of the target content, wherein the motion characteristic comprises rotation of the target content from left to right, from right to left, from top to bottom, or from bottom to top.

10. A method for playing a video, comprising:
obtaining a video source, wherein the video source comprises video content;
parsing the video content in the video source to generate a three-dimensional (3D) image, wherein the 3D image displays an object recorded in the video content;
obtaining a control signal from a user, wherein the control signal reflects an operation intention of the user;
determining a manner of displaying the 3D image; and
displaying the 3D image according to the control signal from the user.

11. The method according to claim 10, wherein obtaining the control signal from the user comprises:
receiving a voice instruction of the user and parsing the voice instruction to obtain the control signal;
detecting a control action of the user and parsing the control action to obtain the control signal;
detecting a focus point change or a focus direction change of a line of sight of the user to obtain the control signal; or
obtaining the control signal by detecting an operation performed by the user on an input apparatus.

12. The method according to claim 10, wherein determining the manner of displaying the 3D image and displaying the 3D image according to the control signal from the user comprises:
displaying the 3D image in a rotating manner according to the control signal;
displaying the 3D image after a visual angle is adjusted according to the control signal; and
displaying the 3D image after a magnification scale is adjusted according to the control signal.

13. A terminal device, comprising:
a receiver circuit configured to obtain a control signal from a user, wherein the control signal reflects an operation intention of the user;
a processor coupled to the receiver circuit and configured to:
determine a manner of displaying video content according to the control signal from the user; and
determine a video playback control instruction according to characteristic information of the video content and the manner of displaying the video content, wherein the video playback control instruction comprises a playback start location and a playback manner; and
a display coupled to the processor and configured to display and play the video content under control of the video playback control instruction.

14. The terminal device according to claim 13, wherein the receiver circuit is further configured to obtain a video source, wherein the video source comprises the video content, and wherein the display is further configured to display a preview picture of the video or play the video content before the receiver circuit obtains the control signal from the user.

15. The terminal device according to claim 13, wherein the receiver circuit is further configured to:
receive a voice instruction of the user and parse the voice instruction to obtain the control signal;
detect an action of the user and parse the control action to obtain the control signal;
detect a focus point change or a focus direction change of a line of sight of the user to obtain the control signal; or
obtain the control signal by detecting an operation performed by the user on an input apparatus connected to the receiver circuit.

16. The terminal device according to claim 13, wherein the receiver circuit is further configured to adjust the control signal according to an action speed of the action or an action speed of the operation performed by the user on the input apparatus connected to the receiver circuit, wherein the processor is configured to determine the manner of displaying the video content according to the control signal from the user and determine the video playback control instruction according to the characteristic information of the video content and the manner of displaying the video content, wherein the video playback control instruction comprises the playback start location and the playback manner, and wherein the manner of displaying the video content comprises forward playback, reverse playback, loop playback, playback stopping; playing the video at an accelerated speed, at a decelerated speed, at a normal speed, playing the video after a particular location or time is jumped to, or playing the video from a particular location or time.

17. The terminal device according to claim 13, wherein the processor is further configured to:
determine a target image requirement and a motion direction requirement of video content playback according to the control signal input from user, wherein a target image corresponds to a target frame;
determine the manner of displaying the video content according to the target image requirement and the motion direction requirement of video content playback; and
determine the video playback control instruction according to the characteristic information of the video content and the manner of displaying the video content, wherein the video playback control instruction comprises the playback start location and the playback manner.

18. The terminal device according to claim 13, wherein the processor is further configured to:
parse the video source to obtain a video frame from the video source, a frame number of each video frame, and the characteristic information of the video content;
determine a frame number of a to-be-played target frame according to the characteristic information of the video content and the manner of displaying the video content, wherein the frame number of the target frame corresponds to a video playback start location or a video playback continuation location; and
determine a playback sequence for playing the target frame according to the frame number of the target frame and the manner of displaying the video content, wherein the playback sequence corresponds to a manner of playing the target frame.

19. A terminal, comprising:
a receiver circuit configured to obtain a video source and a control signal from a user, wherein the video source comprises video content, and wherein the control signal reflects an operation intention of the user;
a processor coupled to the receiver circuit and configured to:
parse the video content in the video source to generate a three-dimensional (3D) image, wherein the 3D image displays an object recorded in the video content; and
determine a manner of displaying the 3D image according to the control signal from the user; and
a display coupled to the processor and configured to display the 3D image under control of the processor.

20. The terminal according to claim 19, wherein the receiver circuit is further configured to obtain the video source, and wherein the receiver is further configured to:
receive a voice instruction of the user and parse the voice instruction to obtain the control signal;
detect an action of the user and parse the control action to obtain the control signal;
detect a focus point change or a focus direction change of a line of sight of the user to obtain the control signal; or
obtain the control signal by detecting an operation performed by the user on an input apparatus connected to the receiver circuit.
